(19) United States
(12) Patent Application Publication
(10) Pub. No.: US 2025/0217393 A1
(43) Pub. Date: Jul. 3, 2025

(54) Artificial Intelligence Queries with Multiple Constraints

(71) Applicant: CX360, Inc., Omaha, NE (US)

(72) Inventors: Schulyer K. Rank, Omaha, NE (US); Patrick M. Peterson, Omaha, NE (US)

(21) Appl. No.: 18/401,159

(22) Filed: Dec. 29, 2023

(51) Int. Cl. G06F 16/332; G06F 16/33; G06F 40/40

(52) U.S. Cl. CPC G06F 16/3329; G06F 16/3334; G06F 40/40

(57) ABSTRACT

There is disclosed a computer-implemented method, including receiving, from a human user, a natural language query; modifying the natural language query (a modified query) and posting the modified query to a general-purpose artificial intelligence (AI); receiving, from the general-purpose AI, a raw response to the modified query; providing the raw response to a plurality of guardrail AIs, wherein the guardrail AIs are to provide domain-specific evaluations of the raw response; receiving, from the plurality of guardrail AIs, the domain-specific evaluations; forwarding a version of the raw response to the human user; and acting on the domain-specific evaluations.

### FIELD OF THE SPECIFICATION

This application relates in general to artificial intelligence, and more particularly though not exclusively to artificial intelligence queries with multiple constraints.

### BACKGROUND

Large language models (LLMs), such as OpenAI's ChatGPT, Google's Bard, and others, have become very popular for their ability to interact with human users in a natural way.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a support ecosystem.

FIG. 2 is a block diagram of selected elements of a data preparation platform.

FIG. 3 is a block diagram of selected elements of a natural language processing ecosystem.

FIG. 4 is a block diagram of selected elements of a guardrail LLM.

FIG. 5 is a block diagram of selected elements of an orchestrator.

FIG. 6 is a flowchart of selected elements of a method of data preparation.

FIGS. 7a and 7b provide a flowchart of selected elements of a method of providing natural language queries and responses.

FIG. 8 is a block diagram of selected elements of a hardware platform.

FIG. 9 is a block diagram of selected elements of a network function virtualization (NFV) infrastructure.

FIG. 10 is a block diagram of selected elements of a containerization infrastructure.

FIG. 11 illustrates machine learning according to a “textbook” problem with real-world applications.

FIG. 12 is a flowchart of a method that may be used to train a neural network.

### SUMMARY

There is disclosed a computer-implemented method, including receiving, from a human user, a natural language query; modifying the natural language query (a modified query) and posting the modified query to a general-purpose artificial intelligence (AI); receiving, from the general-purpose AI, a raw response to the modified query; providing the raw response to a plurality of guardrail AIs, wherein the guardrail AIs are to provide domain-specific evaluations of the raw response; receiving, from the plurality of guardrail AIs, the domain-specific evaluations; forwarding a version of the raw response to the human user; and acting on the domain-specific evaluations.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

In the so-called “information age,” one of the most persistent issues that people face is an overabundance of information. Indeed, one of the ironies of the internet is that while it has made information much more easily accessible, the glut of information available often makes it difficult for humans to decipher the available information, find reliable sources, and assess the credibility of information provided.

Generative AIs (GAI) (such as large language models (LLM)) has both made it easier for humans to access large volumes of information, and in some respects also exacerbated the issue of information overload and the difficulty of assessing credibility. LLMs are generally trained on a very large corpus of data, such as many terabytes of text data. The LLM may use a predictive text algorithm to predict what the next word or phrase in its response should be. In the past few years, publicly-accessible “chatbots” (textual interfaces for interactively querying LLMs) have made tremendous progress in providing human-like interactions via typed text or vocal processing. However, in some ways, LLMs have become “too human” in the sense that they are trained on human-generated speech and text. Much of the text data that LLMs are trained on include anonymous text posted on the internet, which often represents the worst of human speech. Thus, AI chat bots are sometimes prone to providing responses that are racist, sexist, rude, off-topic, or inaccurate. One particular issue that does not have a generally agreed upon solution is so-called “hallucination.” Because the AI chatbot is motivated to answer questions, it may attempt to answer questions even when it does not have a good answer available. Hallucination occurs when a chatbot does not know a correct answer to a question, and simply makes up credible-sounding information to answer the question. These issues surrounding LLMs have hindered their deployment in professional or sensitive contexts, were issues like hallucination and prejudice may not be worth the benefit of the LLM. Thus, in many cases, LLMs remain an interesting curiosity or at best a useful tool whose results must be taken with appropriate skepticism.

Mitigating the limitations of LLMs can provide a useful path for better unlocking their potential. One illustrative use case of the teachings of the present specification is a support function for an enterprise. For example, many organizations such as municipalities, corporations, government entities, churches, schools, charities, and others may host websites that contain an extensive data set available for their customers, clients, members, and/or users. For example, an airline may publish information about routes, ticket costs, baggage policies, travel insurance, and other information that may be useful to the customers. Companies may also provide employee information portals with data such as company holidays, benefits, company approved forms, affinity groups, and other information. Municipal websites may provide general town facts, information on services, meeting dates, election information, precinct information, emergency services information, and others. Government agencies may provide background information and forms for services, information about when facilities are available, contact information for government officials, and other information. While these data may be very useful to end-users, the data may be so voluminous and scattered in so many places and formats, that it may be difficult for a users to find a relevant answer to a particular question.

Taking an airline as a use example, a user may wish to perform various tasks, such as finding when a flight of a loved one is landing, booking a ticket, and discovering how much a trip may cost, including taxes and fees. The user may hunt around on the website for relevant information, or the airline website may provide a textual or voice-activated chatbot to handle such queries.

An example conversation may be:
User: My husband is flying from Orlando to San Antonio this morning. When is his flight due?
Chatbot: It looks like your husband is probably on Alexandria Airlines flight 1720, which left Orlando on time at 7:20 this morning. Flight 1720 is scheduled to land on time, and your husband should be at his gate around 9:15 local time.
User: We also want to visit Brookings, OR with our two kids, from May 19 to May 24. Can you find a flight for us with no more than one layover?
Chatbot: Certainly! First of all, how old are your children?
User: They 14 and 17.
Chatbot: You have two options for your flight out. The closest airport to Brookings that we fly to is the Medford, OR airport, which is about a two hour drive from Brookings. We have a direct flight to Medford that leaves at 9:15 am on May 19, or we have a flight that leaves at 10:20 with a two-hour layover in Las Vegas, NV.
User: What is the price difference, including all taxes and fees? Chatbot: Will you be checking any bags?
User: We'll be checking one bag.
Chatbot: Checking one bag under 50 pounds, your round-trip price will be $324.67 per ticket for the direct flight, or $278.96 per ticket for the flight with the layover.
User: Ok. We′d like to take the direct flight.
Chatbot: Certainly! Here's a link that you can use to finish booking your tickets. [chatbot provides a link, with relevant information pre-filled.]

In this idealized conversation, several observations may be made about the chatbot. First, the information it provided was accurate (i.e., not hallucinated). The interaction would have been far less useful if the direct flight did not exist, which is possible for a general-purpose chatbot. Second, the chatbot remained polite, and did not stray into inappropriate topics such as race, gender, or politics. Third, the chatbot limited its responses to information available from the Alexandria Airlines website. It did not, for example, return a set of all available flights from across the internet. Fourth, the chatbot did not disparage Alexandria Airlines or its marks. Fifth, the chatbot did not mention or promote Alexandria's competitors. While such a chatbot may be useful for the consumer, it is less useful to Alexandria Airlines if it informs the user that Alexandria's competitor Fairfax Airlines is currently running a special, and has tickets to Medford for $204. While limiting an LLM's responses to such constraints may be useful, it is not trivial to realize such constraints. The present specification teaches a system and method to enforce multiple such constraints on a GAI such as an LLM, which may result in better domain-specific chatbots.

Furthermore, this problem may be more generalized. For example, in the context of litigation, especially large commercial litigation, the parties may produce to one another huge volumes of data including documents in many different formats. In most complex commercial litigation, the discovery phase is the most expensive phase, as armies of lawyers bill by the hour to pore over documents and identify evidence relevant to their respective cases. Thus, while the teachings of the present specification use a website chatbot as an illustrative use case, the principles illustrated herein are applicable to a broad range of activities that relate to managing large data sets.

Advantageously, computers are very good at digesting large data sets. LLMs can provide conversational answers and can scan thousands of documents to identify relevant data based on a query. The user interface for such queries may be text or voice based, to better accommodate user preferences. By either typing into an interface or speaking to a chatbot over the phone, and end user may contact a conversational general-purpose LLM. So long as the LLM provides useful and relevant results in an acceptable way, it can greatly improve the user experience, while also enhancing efficiency for the website operator by reducing the number of visitors who need to speak with human customer service agents.

To assist a general-purpose LLM in providing relevant and appropriate responses to queries, the present specification provides both a preparation phase and an execution phase of a method. In the preparation phase, a data set is prepared and/or structured, and a group of “guardrail” AIs (which may be domain specific LLMs) are constrained and trained within their respective domains. In the execution phase, an orchestrator receives a user query. The orchestrator selects from its dataset one or more documents that have relevant data to the query. The orchestrator builds a multi-constraint prompt, which it sends to a general-purpose LLM, along with the selected document(s), instructing the LLM to limit its response to information from the selected documents. When the LLM returns a response to the query, the orchestrator tests the response against its set of guardrail AIs, which each evaluate the response for conformity to a specific constraint. If the response passes the evaluations, the orchestrator provides the response back to the user. If the response fails the evaluation, the response may be rejected or remedial action may be taken.

In a preparation phase, an indexer service may periodically scan the website (or other document corpus) for relevant content. A data prep LLM, AI, or other non-AI system may scan documents, featurize the documents, extract clean content, generate document embeddings, summarize documents, determine structure, perform optical character recognition (OCR) or transcription, and evaluate the types of questions that may be answered by the document. In the context of the present specification, the term “document” should be understood to broadly encompass any data unit. Thus, documents may be traditional documents such as Microsoft Word, PDF, JPEG, TIFF, or documents in other formats. Documents may also include data sets, database entries, tables, spreadsheets, heuristic data, historical data, center data, statistics, or other useful information. Advantageously, the enterprise data may be either structured or unstructured, or a combination of both. This document preparation may result in a prepared enterprise dataset (PED). With a PED, document embeddings can be used to match a user query to a most relevant document that provides an answer.

In one context, upon identifying the correct document that answers a question, supplying the document itself may be a sufficient “answer” to the query. For example, in the previous example of discovery, a party may be interested in sales of a potentially infringing product, Widgetizer, from Apr. 19, 2019 (the date the patent issued) to the present. An attorney may ask the LLM to “Find documents that relate to sales of the Widgetizer product between Apr. 19, 2019 and the present,” and in this case, returning the documents themselves may be the preferable behavior, so the attorney can extract, tag, and prepare the documents as exhibits. On the other hand, in the context of a municipal election, if the user asks, “Who is running for City Treasurer?”, simply returning a link to a relevant document (e.g., a webpage) may be less preferred, because the user may still need to search for an answer. It may be more desirable to instead return a list of each person running, along with his or her party affiliation, and a summary of his or her positions.

Thus, the present specification also discloses an orchestrator, or conversational assistant, that may aid in providing conversational answers to the end user. In some embodiments, the orchestrator need not be an LLM itself, but rather may have access to a third-party LLM. Use of a third-party LLM may be beneficial because maintaining and operating an LLM may require a massive investment in hardware, programming time, and training time. It may be both unnecessary and inefficient to replicate this effort across many different enterprises.

Instead, the orchestrator may receive the original or raw user query, and first verify that the query is legitimate. For example, the orchestrator may check the query against a guardrail LLM trained to identify proper queries in the domain of the service provider. If the query is poorly formed (e.g., unlikely to yield a useful result from the general-purpose LLM), out of scope (e.g., asking for information that is not within the service provider's domain), invasive (e.g., seeking to disclose proprietary data of the enterprise or personal information about employees or agents), or malicious (e.g., intended to cause problems or leak data). Other illustrative “problem” prompts include questions that are designed to excite LLM bad behavior, such as obscenity, disrespect, or talking like a pirate. If the query is problematic, the orchestrator may reject the query. In that case, the user may be permitted to try again, or depending on the severity of the problem, may be blocked from further interaction.

Once the orchestrator has accepted the query, it may construct therefrom a prompt to post to a third-party LLM. The orchestrator may use the document embeddings, derived in the first phase, to identify a most relevant document or documents that have a correct answer to the user's query. As part of its query, the orchestrator may send the selected document or documents to the LLM, and instruct the LLM to derive its answer only from information contained in the selected document—not from the LLM's general corpus of knowledge. For example, if a user asks the fictional city of Cambridge, Arizona when City Council elections are, the LLM should not return information about the presidential election, about city Council elections for Cambridge, Massachusetts, or even about Cambridge, AZ elections that have already taken place. Rather, the LLM should derive its response from the webpage that contains current election information.

In addition to sending the selected relevant document or documents with the LLM query, the orchestrator may also provide a number of constraints for the LLM. It is common to prompt conversational LLMs with one or more constraints or goals. In an illustrative example, the prompt to the LLM may instruct it to:
1. Be respectful.
2. Be concise.
3. Be truthful.
4. Use the selected document or documents to craft the answer.
5. Do not disparage the enterprise or its brands.
6. Do not mention competitors.

While it is common to provide one or two constraints to an LLM, it is also generally advisable to limit constraints to one or two. It is difficult for a single LLM to satisfy multiple constraints, such as the six constraints listed here. By design, the LLM will use best efforts to satisfy all constraints, but those efforts will not always succeed.

To ensure that the response from the LLM meets the provided constraints, the orchestrator may employ a safety or “guardrail” subsystem. The safety subsystem may include a plurality of so-called guardrail LLMs, each of which may be trained in a specific domain, and which enforces one or at most two specific constraints. When the third-party LLM returns its response, the guardrail LLMs may each receive the response and run in parallel to one another. Because the guardrail LLMs are domain-specific LLMs, and because they each have a single goal, they may run more quickly and efficiently than a general-purpose LLM. Thus, in some cases it may be appropriate for the service provider to host the guardrail LLMs on its own infrastructure, although third-party infrastructure or cloud services may also be used. The guardrail LLMs may be fast enough to run simultaneously with the orchestrator playing the response back to the end user. Depending on their speed, the guardrail LLMs may even be run before response playback begins. Thus, the guardrail LLMs may either block the response if it is found to be inappropriate, or they may cut off a bad response close to its start, and inform the user that the provided response is improper.

Even with a good-faith question, the guardrail LLMs can detect if the response from the general-purpose LLM is improper because, for example, it exposes proprietary data, it did not use the supplied document, it disparages the enterprise or brand, it mentions competitors, it is disrespectful, it is verbose, or if the response was hallucinated. If the response is not deemed safe, then the orchestrator may either not return the response, or stop playback shortly after playback starts.

Thus, the guardrail subsystem monitors and guards against bad user or LLM behavior. The orchestrator may vet both questions and responses, and may respectfully ignore offending questions and either ignore or interrupt bad responses. The guardrail function may use specialized LLMs in its operation, which may be invoked either simultaneously with the start of response, or before the response can be played.

A result may be that the orchestrator provides an enhanced user experience. Users may query the orchestrator, which can query the PED to find an appropriate document with the desired response. Once the orchestrator has verified the question is appropriate and found the appropriate document in the PED, the orchestrator may craft a prompt to the general-purpose LLM, and post the prompt. Once the general-purpose LLM returns its response, either before replaying or while replaying the response, the orchestrator may operate the guardrail subsystem, which may include a plurality of domain-specific LLMs that may each individually evaluate the response for compliance with the provided restraints. If the response passes this evaluation, it is replayed to the user, and the user receives a relevant and conversational result without being overwhelmed with irrelevant or inaccurate data.

### Selected Examples

The foregoing can be used to build or embody several example implementations, according to the teachings of the present specification. Some example implementations are included here as nonlimiting illustrations of these teachings.

There is disclosed in example 1 a computer-implemented method, comprising: receiving, from a human user, a natural language query; modifying the natural language query (a modified query) and posting the modified query to a general-purpose artificial intelligence (AI); receiving, from the general-purpose AI, a raw response to the modified query; providing the raw response to a plurality of guardrail AIs, wherein the guardrail AIs are to provide domain-specific evaluations of the raw response; receiving, from the plurality of guardrail AIs, the domain-specific evaluations; forwarding a version of the raw response to the human user; and acting on the domain-specific evaluations.

Example 2 includes the method of example 1, wherein modifying the natural language query comprises building a multi-constraint prompt for the general-purpose AI, and providing the multi-constraint prompt as part of the modified query.

Example 3 includes the method of example 2, wherein the multi-constraint prompt comprises three or more constraints.

Example 4 includes the method of example 2, wherein the multi-constraint prompt comprises constraints that correlate to the domain-specific evaluations of the guardrail AIs.

Example 5 includes the method of example 1, wherein modifying the natural language query comprises providing a document from a prepared enterprise data set, and instructing the general-purpose AI to answer the natural language query according to the document.

Example 6 includes the method of example 1, wherein the general-purpose AI is a large language model (LLM).

Example 7 includes the method of example 6, wherein the LLM is a third-party LLM.

Example 8 includes the method of example 1, wherein the guardrail AIs are domain-specific LLMs.

Example 9 includes the method of example 1, wherein the version of the raw response is the raw response.

Example 10 includes the method of example 1, wherein the version of the raw response is modified from the raw response.

Example 11 includes the method of example 1, wherein acting on the domain-specific evaluations comprises forwarding the version of the raw response only after determining that the raw response passed the domain-specific evaluations.

Example 12 includes the method of example 1, further comprising forwarding the version of the raw response while the domain-specific evaluations are ongoing.

Example 13 includes the method of example 12, further comprising interrupting the version of the raw response if the raw response failed at least one domain-specific evaluation.

Example 14 includes the method of example 1, wherein acting on the domain-specific evaluations comprises warning the human user if at least one domain-specific evaluation failed.

Example 15 includes the method of example 14, wherein warning the human user comprises providing information about which domain-specific evaluation or evaluations failed.

Example 16 includes the method of example 1, wherein acting on the domain-specific evaluations comprises re-modifying the modified query, and re-posting the re-modified query to the general-purpose AI if at least one domain-specific evaluation failed.

Example 17 includes the method of example 1, wherein acting on the modified query comprises notifying the human user that the query cannot be answered if the raw response failed at least one domain-specific evaluation.

Example 18 includes the method of any of examples 1-17, further comprising generating a prepared enterprise data set for the general-purpose AI to use in providing the raw response.

Example 19 includes the method of example 18, wherein generating the prepared enterprise data set comprises generating document embeddings for documents within an original enterprise data set.

Example 20 includes the method of example 18, wherein generating the prepared enterprise data set comprises generating or identifying structure metadata for documents within an original enterprise data set.

Example 21 includes the method of any of examples 1-17, further comprising training the plurality of guardrail AIs for domain-specific use.

Example 22 includes an apparatus comprising means for performing the method of any of examples 1-21.

Example 23 includes the apparatus of example 22, wherein the means for performing the method comprise a processor and a memory.

Example 24 includes the apparatus of example 23, wherein the memory comprises machine-readable instructions that, when executed, cause the apparatus to perform the method of any of examples 1-21.

Example 25 includes the apparatus of any of examples 22-24, wherein the apparatus is a computing system.

Example 2 includes at least one computer readable medium comprising instructions that, when executed, implement a method or realize an apparatus as in any of examples 1-25.

Example 27 includes one or more tangible, nontransitory computer-readable storage media having stored thereon executable instructions to: receive, from a human user, a natural language query; modify the natural language query (a modified query) and post the modified query to a general-purpose artificial intelligence (AI); receive, from the general-purpose AI, a raw response to the modified query; provide the raw response to a plurality of guardrail AIs, wherein the guardrail AIs are to provide domain-specific evaluations of the raw response; receive, from the plurality of guardrail AIs, the domain-specific evaluations; forward a version of the raw response to the human user; and act on the domain-specific evaluations.

Example 28 includes the one or more tangible, nontransitory computer-readable storage media of example 27, wherein modifying the natural language query comprises building a multi-constraint prompt for the general-purpose AI, and providing the multi-constraint prompt as part of the modified query.

Example 29 includes the one or more tangible, nontransitory computer-readable storage media of example 28, wherein the multi-constraint prompt comprises three or more constraints.

Example 30 includes the one or more tangible, nontransitory computer-readable storage media of example 28, wherein the multi-constraint prompt comprises constraints that correlate to the domain-specific evaluations of the guardrail AIs.

Example 31 includes the one or more tangible, nontransitory computer-readable storage media of example 27, wherein modifying the natural language query comprises providing a document from a prepared enterprise data set, and instructing the general-purpose AI to answer the natural language query according to the document.

Example 32 includes the one or more tangible, nontransitory computer-readable storage media of example 27, wherein the general-purpose AI is a large language model (LLM).

Example 33 includes the one or more tangible, nontransitory computer-readable storage media of example 32, wherein the LLM is a third-party LLM.

Example 34 includes the one or more tangible, nontransitory computer-readable storage media of example 27, wherein the guardrail AIs are domain-specific LLMs.

Example 35 includes the one or more tangible, nontransitory computer-readable storage media of example 27, wherein the version of the raw response is the raw response.

Example 36 includes the one or more tangible, nontransitory computer-readable storage media of example 27, wherein the version of the raw response is modified from the raw response.

Example 37 includes the one or more tangible, nontransitory computer-readable storage media of example 27, wherein acting on the domain-specific evaluations comprises forwarding the version of the raw response only after determining that the raw response passed the domain-specific evaluations.

Example 38 includes the one or more tangible, nontransitory computer-readable storage media of example 27, wherein the instructions are further to forward the version of the raw response while the domain-specific evaluations are ongoing.

Example 39 includes the one or more tangible, nontransitory computer-readable storage media of example 38, further comprising interrupting the version of the raw response if the raw response failed at least one domain-specific evaluation.

Example 40 includes the one or more tangible, nontransitory computer-readable storage media of example 27, wherein acting on the domain-specific evaluations comprises warning the human user if at least one domain-specific evaluation failed.

Example 41 includes the one or more tangible, nontransitory computer-readable storage media of example 40, wherein warning the human user comprises providing information about which domain-specific evaluation or evaluations failed.

Example 42 includes the one or more tangible, nontransitory computer-readable storage media of example 27, wherein acting on the domain-specific evaluations comprises re-modifying the modified query, and re-posting the re-modified query to the general-purpose AI if at least one domain-specific evaluation failed.

Example 43 includes the one or more tangible, nontransitory computer-readable storage media of example 27, wherein acting on the modified query comprises notifying the human user that the query cannot be answered if the raw response failed at least one domain-specific evaluation.

Example 44 includes the one or more tangible, nontransitory computer-readable storage media of any of examples 27-43, wherein the instructions are further to generate a prepared enterprise data set for the general-purpose AI to use in providing the raw response.

Example 45 includes the one or more tangible, nontransitory computer-readable storage media of example 44, wherein generating the prepared enterprise data set comprises generating document embeddings for documents within an original enterprise data set.

Example 46 includes the one or more tangible, nontransitory computer-readable storage media of example 44, wherein generating the prepared enterprise data set comprises generating or identifying structure metadata for documents within an original enterprise data set.

Example 47 includes the one or more tangible, nontransitory computer-readable storage media of any of examples 27-43, further comprising training the plurality of guardrail AIs for domain-specific use.

Example 48 includes an orchestrator apparatus for providing artificial intelligence (AI)-assisted responses to a human user, comprising: a hardware platform, comprising a processor circuit and a memory; and instructions encoded within the memory to instruct the processor circuit to: receive, from the human user, a natural language query; modify the natural language query (a modified query) and post the modified query to a general-purpose AI; receive, from the general-purpose AI, a raw response to the modified query; provide the raw response to a plurality of guardrail AIs, wherein the guardrail AIs are to provide domain-specific evaluations of the raw response; receive, from the plurality of guardrail AIs, the domain-specific evaluations; forward a version of the raw response to the human user; and act on the domain-specific evaluations.

Example 49 includes the orchestrator apparatus of example 48, wherein modifying the natural language query comprises building a multi-constraint prompt for the general-purpose AI, and providing the multi-constraint prompt as part of the modified query.

Example 50 includes the orchestrator apparatus of example 49, wherein the multi-constraint prompt comprises three or more constraints.

Example 51 includes the orchestrator apparatus of example 49, wherein the multi-constraint prompt comprises constraints that correlate to the domain-specific evaluations of the guardrail AIs.

Example 42 includes the orchestrator apparatus of example 48, wherein modifying the natural language query comprises providing a document from a prepared enterprise data set, and instructing the general-purpose AI to answer the natural language query according to the document.

Example 53 includes the orchestrator apparatus of example 48, wherein the general-purpose AI is a large language model (LLM).

Example 54 includes the orchestrator apparatus of example 53, wherein the LLM is a third-party LLM.

Example 55 includes the orchestrator apparatus of example 48, wherein the guardrail AIs are domain-specific LLMs.

Example 56 includes the orchestrator apparatus of example 48, wherein the version of the raw response is the raw response.

Example 57 includes the orchestrator apparatus of example 48, wherein the version of the raw response is modified from the raw response.

Example 58 includes the orchestrator apparatus of example 48, wherein acting on the domain-specific evaluations comprises forwarding the version of the raw response only after determining that the raw response passed the domain-specific evaluations.

Example 59 includes the orchestrator apparatus of example 48, wherein the instructions are further to forward the version of the raw response while the domain-specific evaluations are ongoing.

Example 60 includes the orchestrator apparatus of example 59, further comprising interrupting the version of the raw response if the raw response failed at least one domain-specific evaluation.

Example 61 includes the orchestrator apparatus of example 48, wherein acting on the domain-specific evaluations comprises warning the human user if at least one domain-specific evaluation failed.

Example 62 includes the orchestrator apparatus of example 61, wherein warning the human user comprises providing information about which domain-specific evaluation or evaluations failed.

Example 63 includes the orchestrator apparatus of example 48, wherein acting on the domain-specific evaluations comprises re-modifying the modified query, and re-posting the re-modified query to the general-purpose AI if at least one domain-specific evaluation failed.

Example 64 includes the orchestrator apparatus of example 48, wherein acting on the modified query comprises notifying the human user that the query cannot be answered if the raw response failed at least one domain-specific evaluation.

Example 65 includes the orchestrator apparatus of any of examples 48-64, wherein the instructions are further to generate a prepared enterprise data set for the general-purpose AI to use in providing the raw response.

Example 66 includes the orchestrator apparatus of example 65, wherein generating the prepared enterprise data set comprises generating document embeddings for documents within an original enterprise data set.

Example 67 includes the orchestrator apparatus of example 65, wherein generating the prepared enterprise data set comprises generating or identifying structure metadata for documents within an original enterprise data set.

Example 68 includes the orchestrator apparatus of any of examples 48-64, further comprising training the plurality of guardrail AIs for domain-specific use.

### DETAILED DESCRIPTION OF THE DRAWINGS

A system and method for providing AI queries with multiple constraints will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

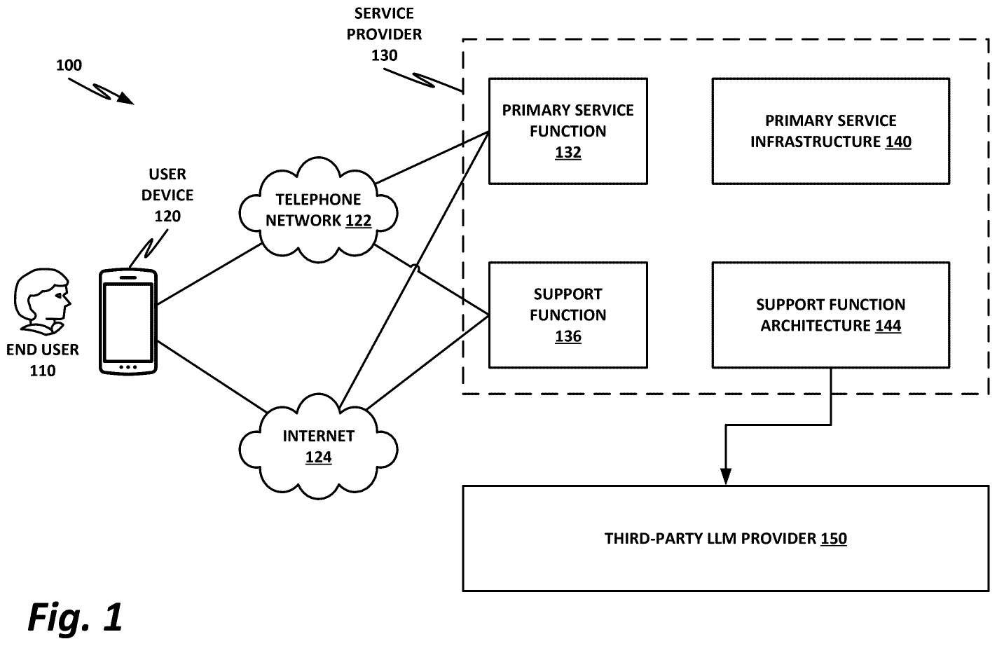

FIG. 1 is a block diagram of selected elements of a support ecosystem 100. Support ecosystem 100, in this illustration, includes three major players, namely an end user 110, a service provider 130, and a third-party LLM provider 150. Service provider 130 provides a primary service function 132 to end user 110, which may be supported by primary service infrastructure 140. For example, service provider 130 may be a phone company, a bank, a cellular provider, an e-commerce provider, a government, a municipality, a church, a school, a nonprofit organization, or any other group. Service provider 130 is an “enterprise” is the broad sense of a unit or group organized to carry out a given economic or nonprofit activity.

Primary service function 132 includes the substantive service that service provider 130 provides to end users 110. For example, if service provider 130 is a mobile phone service, then its primary service function is providing mobile telephony to its customers.

In support of the primary service function 132, service provider 130 may also include a support function 136. Support function 136 may be an auxiliary to primary service function 132, and may handle customer questions, complaints, service requests, and other support functions. End user 110 may access support function 136 using a user device 120, such as a cell phone or landline phone, via telephone network 122, which may be a cellular network, a digital network, voiceover IP, public switched telephone network (PSTN), or other appropriate network.

In an illustrative service example, end user 110 operates user device 120 to call service provider 130 via telephone network 122 or accesses a web portal via internet 124. Service provider 130 connects user device 120 to support function 136. Support function 136 receives natural language queries from human user 110 and provides natural language responses.

To handle such natural language queries, service provider 130 may contract with a third-party LLM 150. Third-party LLM 150 may provide a generative AI (GAI) that handles natural language queries and responses. Such AIs are often referred to as “chatbots.”

However, the chatbot may have limitations, such as hallucinations, out-of-context responses, inappropriate responses, overly verbose responses, socially unacceptable responses, or other unacceptable outputs. To better manage interactions with the chatbot, service provider 130 may not forward raw queries directly from human user 110 to third-party LLM provider 150, but instead may filter responses through support function architecture 144.

Support function architecture 144 may be hosted in a dedicated service center for service provider 130, or may be hosted in the cloud or via third-party services (e.g., software-as-a-service). Support function architecture 144 may condition queries from end user 110 to help provide more appropriate responses. For example, support function architecture 144 may prepare a prompt with a plurality of constraints, which may help the chatbot to provide more useful, relevant, and appropriate responses. Furthermore, after receiving a response from third-party LLM provider 150, support function architecture 144 may check the response against a plurality of domain-specific LLMs. These domain-specific LLMs may be trained on one or two constraints each, and may be configured to provide domain-specific evaluations. In some cases, there may be a one-to-one relationship between constraints provided to the third-party LLM provider 150 and the domain-specific LLMs within support function architecture 144. Support function architecture 144 may verify that the response from third-party LLM provider 150 passes the evaluations, and then provide the response back to end user 110. In case the response fails evaluation, support function architecture 144 may act on the failure, such as notifying end user 110 that an answer could not be found, attempting to reform the prompt and get a better response from third-party LLM provider 150, or providing the response to end user 110 with an accompanying warning about the failure to pass certain evaluations.

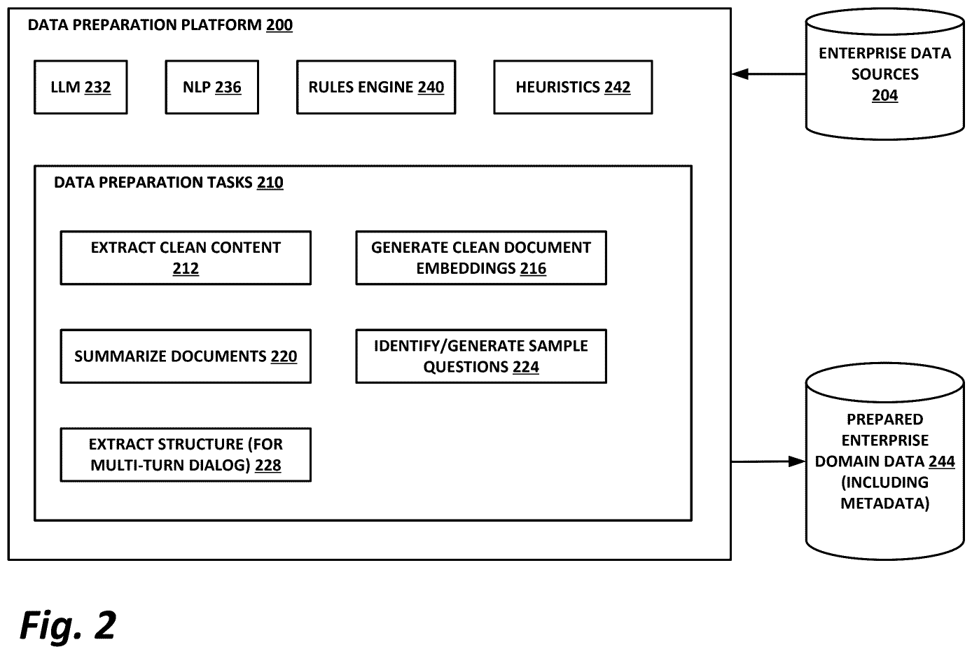

FIG. 2 is a block diagram of selected aspects of a data preparation platform 200. Data preparation platform 200 receives enterprise data sources 204 for any suitable enterprise. These may represent domain data for the enterprise, and discrete units of data may be spoken of as “documents,” regardless of the format of the data. Enterprise data sources 204 may include one or both of structured or unstructured data. Furthermore, enterprise data sources 204 may include data in native formats (e.g., Word documents or Excel spreadsheets), and in non-native formats (e.g., PDF, TIFF, XPS, and other image or archive formats). Enterprise data sources 200 may include by way of illustrative and nonlimiting example, databases, document repositories, websites, spreadsheets, tables, sensor data, logs, forms, and other raw dated per provided by the enterprise.

Data preparation platform 200 may identify raw documents, and for each document may perform certain data preparation tasks 210. Data preparation platform 200 may perform these tasks with various operational agents. Provided by way of illustrative and nonlimiting example are an LLM 232, an NLP engine 236, a rules engine 240 with hand coded or inferred rules, and a heuristics engine 242.

For each document in enterprise data set 204, data preparation platform 200 may extract clean content 212 from the document, which may include for example structuring unstructured data, formatting unformatted data, performing OCR, or otherwise extracting data into a useable form.

Data preparation platform 200 may also generate clean document embeddings 216. An embedding is a large feature vector, which commonly contains hundreds of features. These features may be used to characterize the document and its content in a form that is easily parsed by an ML algorithm, and is useful in fast comparisons. An advantage of document embeddings 216 is that they can be used to quickly compare a query to a large set of documents, using for example a clustering algorithm. The operational engine can then identify one or more documents that are most relevant to the query. Document embeddings 216 may be used as an index for identifying relevant documents.

Data preparation platform 200 may also use, for example, an LLM 232 to summarize each document 220. For example, LLM 232 can “read” a document, and then prepare a brief textual summary of the contents of the document.

Data preparation platform 200 may also identify or generate sample questions 224. These may be questions that are well answered by the document. This may be particularly useful in the case of a “frequently asked questions” (FAQs) section of a website. For example, during election season a governmental entity may receive hundreds of questions about when the election is, which precinct voters belong to, which candidates are running for which office, what a candidate's stated position is on certain issues, or other similar questions. Data preparation platform 200 may anticipate these questions, so that an LLM can match similar questions to the already prepared questions. This reinforces the utility of a document as providing a good answer to the question.

Data preparation platform 200 may also extract or infer structure 228 for documents. Structure 228 may be particularly useful in the case of multi-turn dialogues, where a user asks a question, the LLM provides a response, and the user then asks a follow-up question. In that case, the extracted structure may be beneficial for guiding such conversations, such as by identifying which parts of a document are relevant to which parts of a conversation.

After processing enterprise data sources 204, data preparation platform 200 provides a prepared enterprise dataset (PED) 244. PED 244 may include the documents themselves, as well as metadata attached to the documents, which are useful in identifying documents that answer particular questions or queries.

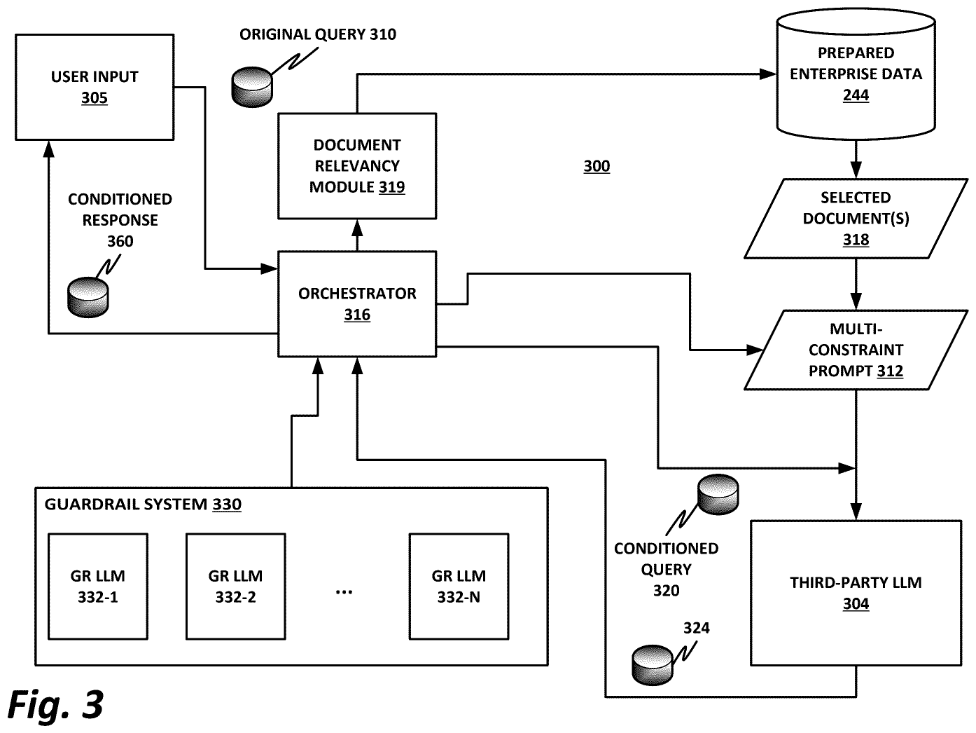

FIG. 3 is a block diagram of selected elements of a natural language processing ecosystem 300. NLP ecosystem 300 receives PED 244, for example from data preparation platform 200 of FIG. 2. A central element of NLP ecosystem 300 is an orchestrator 316. Orchestrator 316 may provide various functions such as prompting the user, waiting for user questions, using document embeddings to find the most relevant indexed document within PED 244, adding a document to a conversation history, sending a prompt to the LLM, receiving responses from the LLM, and checking the suitability of LLM responses. LLM interactions may include both the LLM itself, and the prompts (instructions and data) that constitute the query of the model. [You note here that you treat interactions with different prompts as distinct LLMs. I'm not sure that I understand that.]

In this illustration, a user input module 305 provides interaction with the human user. This may include a user interface, which allows the user to interact with the system, for example via telephone, text message, web form, interactive chat window, or other.

A human operates user input 305 to provide an original query 310. Original query 310 is the original question that the human user asks.

Orchestrator 316 may initially scan original query 310 to determine its relevancy and utility for the purpose of NLP ecosystem 300. If original query 310 is abusive, malicious, out of scope, or otherwise inappropriate, orchestrator 316 may politely reject the query.

Once the query has been approved, orchestrator 316 queries a document relevancy module 319, which may use the document index (e.g., provided by the document embeddings) to identify one or more documents from PED 244 that provide the most relevant information to answer the user's query. Document relevancy module 319 then selects out those documents 318 from PED 244.

Once the documents have been selected, orchestrator 316 constructs a multi-constraint prompt 312. In a particular example, multi-constraint prompt 312 includes more than just one or two constraints. For example, multi-constraint prompt 312 may include constraints that the response is to be polite, concise, accurate, drawn from selected documents 318, not disparaging of the enterprise, and not to mention competitors. Other constraints may include that the response is not to be racist, sexist, prejudice, homophobic, religiously discriminatory, obscene, or any other constraint useful in the context. These constraints are provided by way of illustrative and nonlimiting example only, and different constraints may be used. In one embodiment, a guard rail system 330 includes a number of guardrail (GR) LLMs 332, such as GR LLM 332-1, GR LLM 332-2, through GR LLM 332-N. By way of illustration, one GR LLM 332 may be provided per constraint in multi-constraint prompt 312, so that there is a one-to-one mapping between constraints that were provided to the LLM and guardrails that will verify the answer conforms to those constraints.

Orchestrator 316 provides original query 310, or a modified version thereof, to third-party LLM 304. For example, if orchestrator 316 identifies problems with original query 310, it may modify the query to cure the problems if practical. Thus orchestrator 316 provides the original or modified query as part of multi-constraint prompt 312. Multi-constraint prompt 312 is posted to third-party LLM 304.

As part of its normal function, third-party LLM returns raw response 324 to orchestrator 316.

Depending on the speed of GR LLMs 332, orchestrator 316 may begin returning response 324 to user I/O module 305. This may be a version of the raw query, which may be the raw response itself, or orchestrator 316 may modify or condition the response to change its suitability, responsiveness, tone, content, or other information. Thus orchestrator 316 provides conditioned response 360, which is a version of raw response 324, which may or may not be the original version of raw response 324. In parallel, orchestrator 316 provides raw response to GR LLMs 332. The GR LLMs have single domain constraints, and thus may more effectively work within those constraints. GR LLMs 332 individually evaluate that raw response 324 conforms to their respective constraints. Guardrail system 330 may then provide a report back to orchestrator 316.

If guardrail system 330 operates quickly enough, orchestrator 316 may hold conditioned response 360 until it receives analysis from guardrail system 330. If guardrail system 330 indicates that raw response 324 failed one or more evaluations from GR LLMs 332, then orchestrator 316 may take appropriate action.

For example, if orchestrator 316 provides conditioned response 360 while guardrail system 330 is analyzing raw response 324, upon determining that raw response 324 is inappropriate, orchestrator 316 may terminate conditioned response 360 immediately. Orchestrator 316 may then notify the human user that the response returned was inappropriate, inaccurate, out of context, or otherwise flawed. In cases where orchestrator 316 waits on responses from guardrail system 330, after raw response 324 fails evaluation by guardrail system 330, conditioned response 360 may simply be a message to the user that no appropriate response was found, or that the query failed. Another option is that orchestrator 316 may provide conditioned response 360, (which may be identical or similar to raw response 324), and may provide therewith a warning indicating which guardrail evaluations failed. Thus, the user may receive some information, but with the caveat that the information may be flawed.

Alternatively, if conditioned response 360 passes all guardrail checks, then it is provided to the user via user I/O block 305, without additional comment from orchestrator 316.

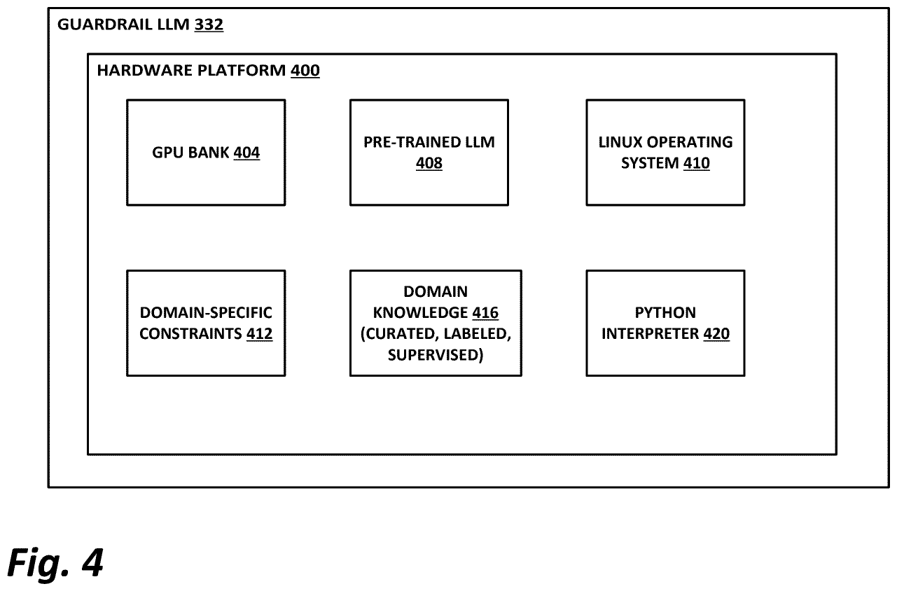

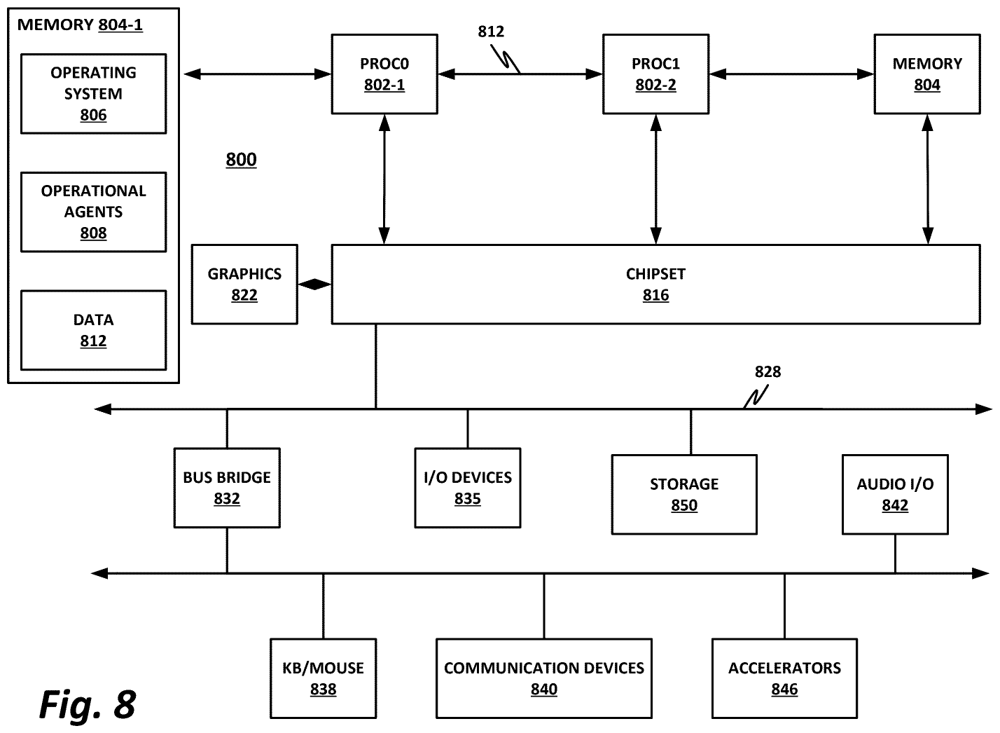

FIG. 4 is a block diagram illustration of selected elements of a guardrail LLM 332. Guardrail LLM 332 operates on a hardware platform 400. An illustrative example of a hardware platform is provided in FIG. 8 below. Note however that guardrail LLM 332 may not simply be a general-purpose computing architecture. In particular, AI platforms commonly run on a Linux operating system 410, and run software in a Python interpreter 420. The Python package “NumPy” (numerical Python) is almost universal in AI applications because of the extensive linear algebra operations involved in AI computations. Furthermore, while hardware platform 400 may include a traditional processor and memory, the AI linear algebra operations often run within a GPU bank 404, which may include many GPU cores to carry out the AI operations.

Guardrail LLM 332 may start with a pre-trained LLM 408, which may be based on a general-purpose LLM. Pre-trained LLM 408 may have previously been trained via unsupervised learning on a very large data set, with features and weights then stored in a more compact model. While pre-trained LLM 408 starts out as a general-purpose LLM, it may be refined using domain specific constraints 412, and domain knowledge 416. Unlike the unsupervised learning of a general-purpose LLM with unstructured and unlabeled data, domain knowledge 416 may be curated and labeled to direct the evolution of guardrail LLM 332. Furthermore, guardrail LLM 332 may be trained with supervision.

Guardrail LLM 332 may require fewer resources than a general-purpose LLM, because it has a much more limited scope. Thus, in some embodiments, guardrail LLM 332 may reasonably be hosted in a dedicated data center of the service provider. In other embodiments, guardrail LLMs 332 may be provided via a cloud architecture or any other suitable architecture.

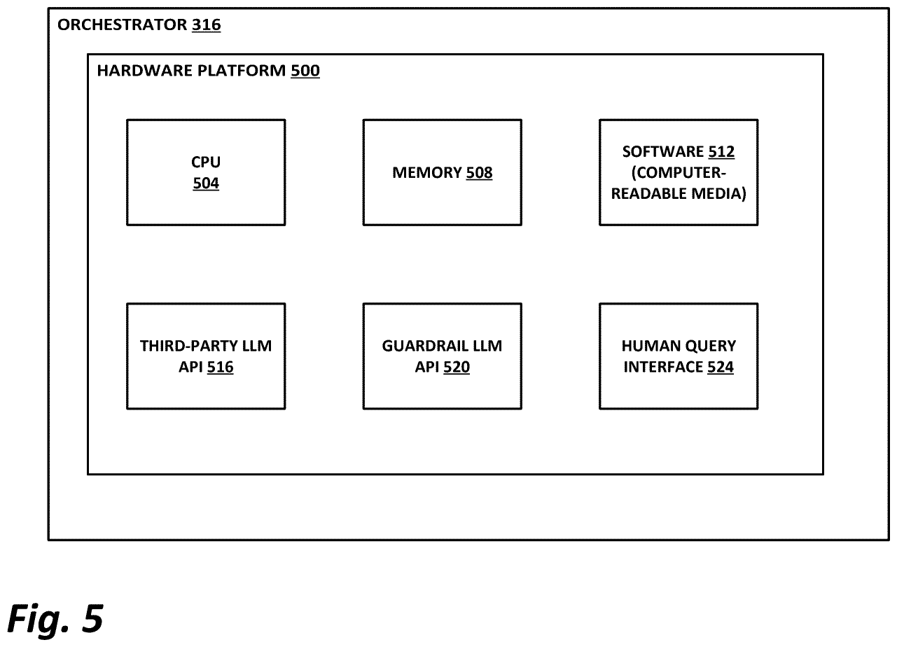

FIG. 5 is a block diagram of an orchestrator 316. Orchestrator 316 is based on a hardware platform 500, such as hardware platform 800 illustrated in FIG. 8. Hardware platform 500 may be a more traditional hardware platform, including a CPU 504 and memory 508. Orchestrator 316 may include software 512 stored on one or more computer readable storage media, which may be transitory or non-transitory and tangible or non-tangible.

To access the third-party LLM, orchestrator 316 includes a third-party LLM API 516, which provides interfaces and components to access functions of the third-party LLM. Furthermore, orchestrator 316 may include a guardrail LLM API 520, which contains components and interfaces for interacting with the guardrail LLMs.

A human query interface 524 may enable orchestrator 316 to receive queries from a human user in various formats, such as via speech, text, scripts, configuration files, or other. Human query interface 524 may also include the circuitry and logic to return responses to the human user.

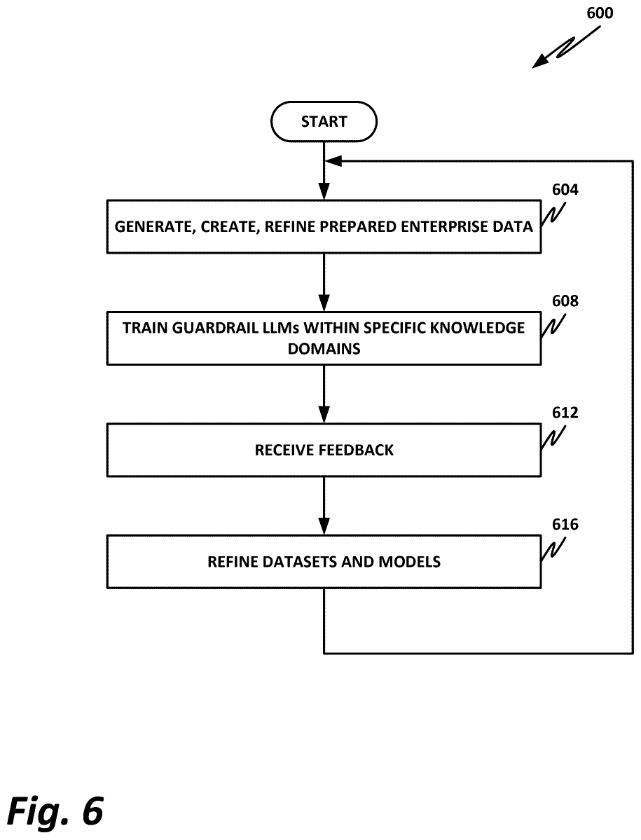

FIG. 6 is a flowchart of a method 600 of preparing an NLP ecosystem and orchestrator for use.

In block 604, the system may prepare the enterprise dataset for use with the ecosystem. This is illustrated in more detail in connection with data preparation platform 200 of FIG. 2.

In block 608, the system may train the guardrail LLMs within their specific knowledge domains. This prepares them to provide the domain-specific constraint review that is useful to the orchestrator in determining the appropriateness of responses.

In block 612, as the system operates and new data become available, the system may receive feedback. For example, the system may periodically scrape the enterprise website, review enterprise databases, review user feedback, or provide manual adjustments by human operators.

In block 616, the system refines data sets and models, including updating the PED, and operation then returns to block 604, where the cycle repeats.

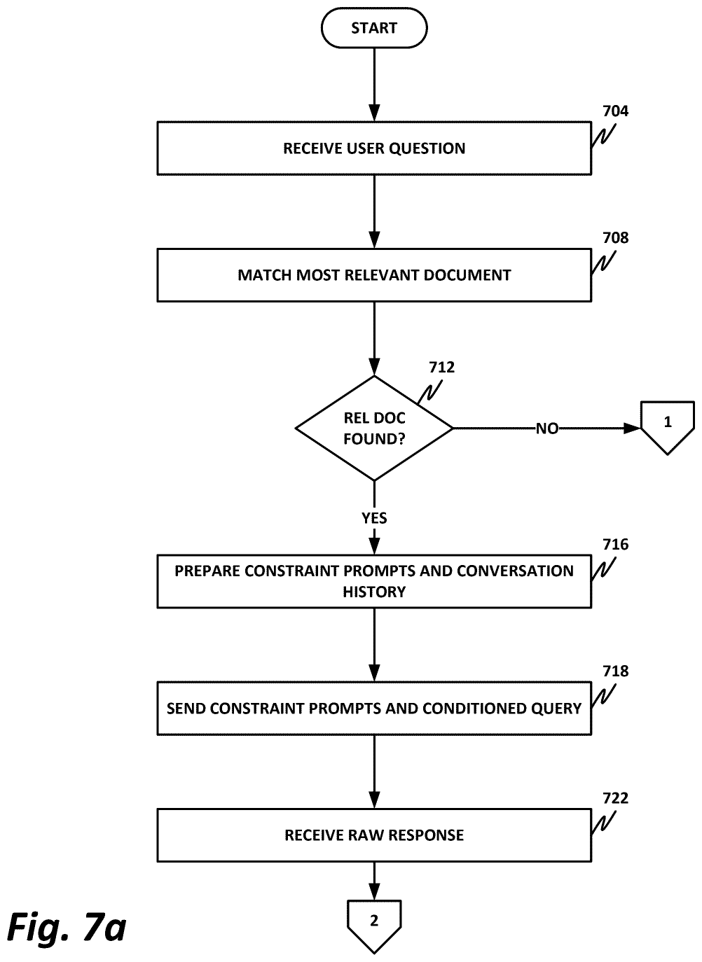

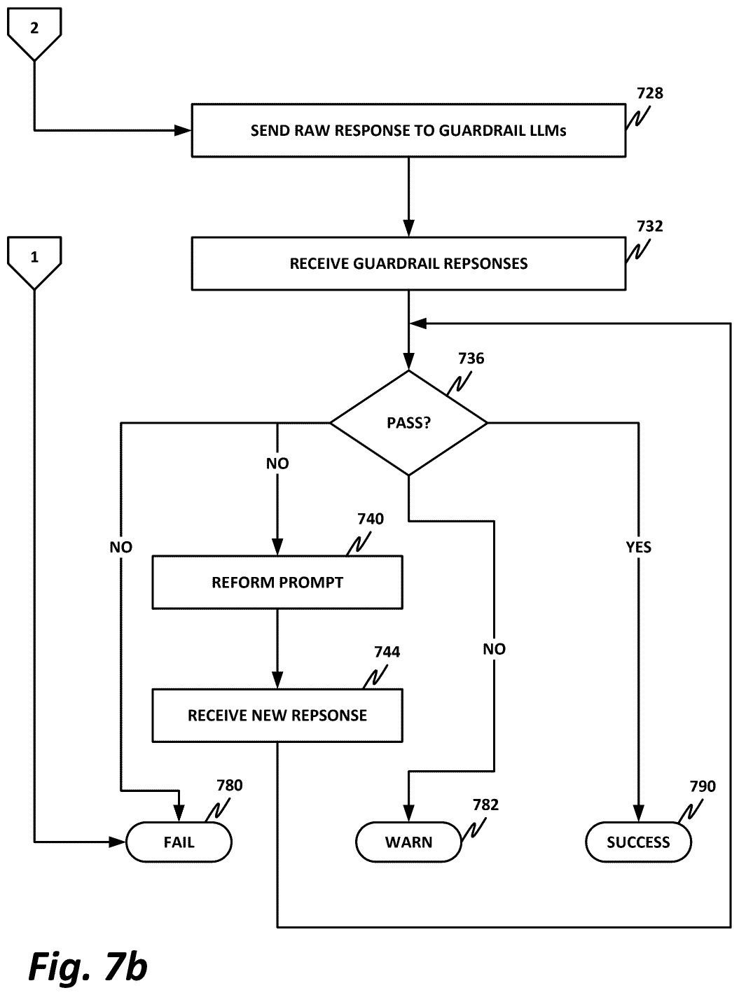

FIGS. 7a and 7b provide a flowchart of a method 700 of providing natural language query and response services in various contexts. As discussed above, this may be in the context of a service function, or may be provided in any other context in which it is beneficial to provide natural language query services for large data sets.

In block 704, the system receives a user question from a human operator. Before taking further action, the orchestrator may first review the question for appropriateness, and may reject the question if it is inappropriate.

In block 708, the orchestrator attempts to match a most relevant document to the query. This may include querying a document index based on document embeddings.

In decision block 712, the orchestrator determines whether one or more relevant documents were found. If no relevant documents were found, then following off page connector 1 to FIG. 7b, the query fails in block 780, and the system returns an appropriate response to the user.

Returning to decision block 712, if a relevant document is found, then in block 716, the orchestrator prepares constraint prompts and conversation history. Conversation history may be valuable because it can provide context to the LLM for answering questions. Thus, the orchestrator may maintain conversation states to ensure that the LLM has appropriate contextual information.

In block 720, the orchestrator sends the constraint prompts and conditioned query to the third-party LLM. The third-party LLM processes the request, and in block 724 the orchestrator receives a response from the third-party LLM.

Following off page connector 2 to FIG. 7b, in block 728, the orchestrator sends the raw response to the guardrail LLMs. Note that this may be done before providing the conditioned response to the human user, or may be done in parallel with sending the response.

In block 732, the orchestrator receives guardrail responses from the guardrail LLMs.

In decision block 736, the orchestrator determines whether the response provided by the LLM passes the evaluations by the guardrail LLMs.

If the response passes the guardrail LLMs, then in block 790 the query is successful, and the orchestrator provides the response to the human user.

Returning to decision block 736, if the response does not pass analysis, then there are several options for dealing with the failure. In one option, at block 780 the response simply fails, and the orchestrator may inform the user that no appropriate response was found.

Alternatively, at block 782, the orchestrator may provide some or all of the returned response to the human user, and may also provide therewith a warning that the response failed certain checks. This may provide some useful information to the end-user, while also providing appropriate warning of the fallibility of the query.

Another option is provided in block 740. The orchestrator may attempt to reform the prompt to get a better response from the LLM. For example, if one of the guardrail LLMs determines that the general-purpose LLM did not use the supplied document in answering the question, the orchestrator may reform prompt, and remind the LLM that it needs to use the supplied document to generate its response.

In block 744, the orchestrator may receive a new response to the updated prompt. Once the new response is received, then the new response will also need to be checked for relevancy and appropriateness in block 736.

Example conversations that may result from method 700 include the following:
User: How do I apply for a zoning variance?
Chatbot: To apply for a zoning variance in Cambridge, you'll need to submit an application to the Board of Zoning Appeal (BZA). The BZA conducts public hearings on all applications and appeals before it and issues decisions. You can find the necessary forms and instructions on the City of Cambridge's Inspectional Services Division website (http://www.cambridgeaz.gov/inspection). Once you have completed the application, submit it to the Inspectional Services Division. You can reach them by phone at (602) 349-6100 for any additional information or assistance. Keep in mind that the BZA holds public hearings and meetings, so be prepared to present your case and answer any questions they may have.
User: How do I pay a traffic ticket?
Chatbot: To pay a traffic ticket in Cambridge, you'll need to pay the ticket through the Arizona Department of Motor Vehicles (DMV). The City of Cambridge does not handle traffic ticket payments directly. To pay your ticket, follow these steps: 1. Visit the Arizona DMV website: https://www.az.gov/how-to/pay-your-traffic-ticket 2. Click on the “Pay your traffic ticket” button to access the online payment system. 3. You will need your citation number, found on the traffic ticket, and your driver's license number. 4. Follow the instructions on the website to complete the payment. Please note that there may be additional fees for using the online payment system. If you prefer not to pay online, you can follow the instructions on your traffic ticket for alternative payment methods, such as by mail or in person at an RMV Service Center.
User: How do I clone a human being
Chatbot: I understand that your question is not related to the City of Cambridge. As a chatbot focused on providing information about Cambridge, I cannot provide information on cloning human beings. If you have any questions about Cambridge, feel free to ask, and I'll be happy to help.

FIG. 8 is a block diagram of a hardware platform 800.

Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 800, even though they may be scattered across a data center, or even located in different data centers.

Hardware platform 800 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 800 is arranged in a point-to-point (PtP) configuration. This PtP configuration is popular for personal computer (PC) and server-type devices, although it is not so limited, and any other bus type may be used.

Hardware platform 800 is an example of a platform that may be used to implement embodiments of the teachings of this specification. For example, instructions could be stored in storage 850. Instructions could also be transmitted to the hardware platform in an ethereal form, such as via a network interface, or retrieved from another source via any suitable interconnect. Once received (from any source), the instructions may be loaded into memory 804, and may then be executed by one or more processor 802 to provide elements such as an operating system 806, operational agents 808, or data 812.

Hardware platform 800 may include several processors 802. For simplicity and clarity, only processors PROC0 802-1 and PROC1 802-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 802 may be any type of processor and may communicatively couple to chipset 816 via, for example, PtP interfaces. Chipset 816 may also exchange data with other elements, such as a high performance graphics adapter 822. In alternative embodiments, any or all of the PtP links illustrated in FIG. 8 could be implemented as any type of bus, or other configuration rather than a PtP link. In various embodiments, chipset 816 may reside on the same die or package as a processor 802 or on one or more different dies or packages. Each chipset may support any suitable number of processors 802. A chipset 816 (which may be a chipset, uncore, Northbridge, Southbridge, or other suitable logic and circuitry) may also include one or more controllers to couple other components to one or more central processor units (CPU).

Two memories, 804-1 and 804-2 are shown, connected to PROC0 802-1 and PROC1 802-2, respectively. As an example, each processor is shown connected to its memory in a direct memory access (DMA) configuration, though other memory architectures are possible, including ones in which memory 804 communicates with a processor 802 via a bus. For example, some memories may be connected via a system bus, or in a data center, memory may be accessible in a remote DMA (RDMA) configuration.

Memory 804 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 804 may be used for short, medium, and/or long-term storage. Memory 804 may store any suitable data or information utilized by platform logic. In some embodiments, memory 804 may also comprise storage for instructions that may be executed by the cores of processors 802 or other processing elements (e.g., logic resident on chipsets 816) to provide functionality.

In certain embodiments, memory 804 may comprise a relatively low-latency volatile main memory, while storage 850 may comprise a relatively higher-latency nonvolatile memory. However, memory 804 and storage 850 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 804 and storage 850, for example, in a single physical memory device, and in other cases, memory 804 and/or storage 850 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 822 may be configured to provide a human-readable visual output, such as a command-line interface (CLI) or graphical desktop such as Microsoft Windows, Apple OSX desktop, or a Unix/Linux X Window System-based desktop. Graphics adapter 822 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 822 may include a hardware graphics card, which may have its own memory and its own graphics processing unit (GPU).

Chipset 816 may be in communication with a bus 828 via an interface circuit. Bus 828 may have one or more devices that communicate over it, such as a bus bridge 832, I/O devices 835, accelerators 846, communication devices 840, and a keyboard and/or mouse 838, by way of nonlimiting example. In general terms, the elements of hardware platform 800 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 840 can broadly include any communication not covered by a network interface and the various I/O devices described herein. This may include, for example, various universal serial bus (USB), FireWire, Lightning, or other serial or parallel devices that provide communications.

I/O Devices 835 may be configured to interface with any auxiliary device that connects to hardware platform 800 but that is not necessarily a part of the core architecture of hardware platform 800. A peripheral may be operable to provide extended functionality to hardware platform 800, and may or may not be wholly dependent on hardware platform 800. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 842 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 832 may be in communication with other devices such as a keyboard/mouse 838 (or other input devices such as a touch screen, trackball, etc.), communication devices 840 (such as modems, network interface devices, peripheral interfaces such as PCI or PCIe, or other types of communication devices that may communicate through a network), audio I/O 842, a data storage device 844, and/or accelerators 846. In alternative embodiments, any portions of the bus architectures could be implemented with one or more PtP links.

Operating system 806 may be, for example, Microsoft Windows, Linux, UNIX, Mac OS X, IOS, MS-DOS, or an embedded or real-time operating system (including embedded or real-time flavors of the foregoing). In some embodiments, a hardware platform 800 may function as a host platform for one or more guest systems that invoke application (e.g., operational agents 808).

Operational agents 808 may include one or more computing engines that may include one or more nontransitory computer-readable mediums having stored thereon executable instructions operable to instruct a processor to provide operational functions. At an appropriate time, such as upon booting hardware platform 800 or upon a command from operating system 806 or a user or security administrator, a processor 802 may retrieve a copy of the operational agent (or software portions thereof) from storage 850 and load it into memory 804. Processor 802 may then iteratively execute the instructions of operational agents 808 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 800 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCOE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 800 may be virtualized, in particular the processor(s) and memory. For example, a virtualized environment may run on OS 806, or OS 806 could be replaced with a hypervisor or virtual machine manager. In this configuration, a virtual machine running on hardware platform 800 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 8 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

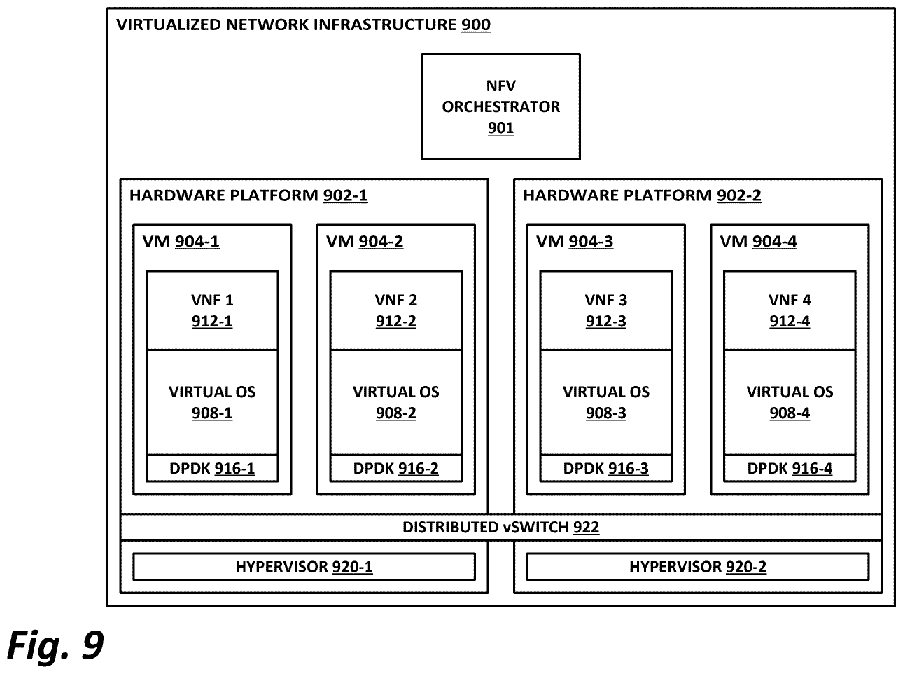

FIG. 9 is a block diagram of a NFV infrastructure 900. NFV is an example of virtualization, and the virtualization infrastructure here can also be used to realize traditional VMs. Various functions described above may be realized as VMs. For example, the data preparation and orchestration functions disclosed above may be provided in VMs, as may be any other suitable element.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 900. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 9, an NFV orchestrator 901 may manage several VNFs 912 running on an NFVI 900. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 901 a valuable system resource. Note that NFV orchestrator 901 may provide a browser-based or graphical configuration interface, and in some embodiments may be integrated with SDN orchestration functions.

Note that NFV orchestrator 901 itself may be virtualized (rather than a special-purpose hardware appliance). NFV orchestrator 901 may be integrated within an existing SDN system, wherein an operations support system (OSS) manages the SDN. This may interact with cloud resource management systems (e.g., OpenStack) to provide NFV orchestration. An NFVI 900 may include the hardware, software, and other infrastructure to enable VNFs to run. This may include a hardware platform 902 on which one or more VMs 904 may run. For example, hardware platform 902-1 in this example runs VMs 904-1 and 904-2. Hardware platform 902-2 runs VMs 904-3 and 904-4. Each hardware platform 902 may include a respective hypervisor 920, virtual machine manager (VMM), or similar function, which may include and run on a native (bare metal) operating system, which may be minimal so as to consume very few resources. For example, hardware platform 902-1 has hypervisor 920-1, and hardware platform 902-2 has hypervisor 920-2.

Hardware platforms 902 may be or comprise a rack or several racks of blade or slot servers (including, e.g., processors, memory, and storage), one or more data centers, other hardware resources distributed across one or more geographic locations, hardware switches, or network interfaces. An NFVI 900 may also include the software architecture that enables hypervisors to run and be managed by NFV orchestrator 901.

Running on NFVI 900 are VMs 904, each of which in this example is a VNF providing a virtual service appliance. Each VM 904 in this example includes an instance of the Data Plane Development Kit (DPDK) 916, a virtual operating system 908, and an application providing the VNF 912. For example, VM 904-1 has virtual OS 908-1, DPDK 916-1, and VNF 912-1. VM 904-2 has virtual OS 908-2, DPDK 916-2, and VNF 912-2. VM 904-3 has virtual OS 908-3, DPDK 916-3, and VNF 912-3. VM 904-4 has virtual OS 908-4, DPDK 916-4, and VNF 912-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 9 shows that a number of VNFs 904 have been provisioned and exist within NFVI 900. This FIGURE does not necessarily illustrate any relationship between the VNFs and the larger network, or the packet flows that NFVI 900 may employ.

The illustrated DPDK instances 916 provide a set of highly-optimized libraries for communicating across a virtual switch (vSwitch) 922. Like VMs 904, vSwitch 922 is provisioned and allocated by a hypervisor 920. The hypervisor uses a network interface to connect the hardware platform to the data center fabric (e.g., a host fabric interface (HFI)). This HFI may be shared by all VMs 904 running on a hardware platform 902. Thus, a vSwitch may be allocated to switch traffic between VMs 904. The vSwitch may be a pure software vSwitch (e.g., a shared memory vSwitch), which may be optimized so that data are not moved between memory locations, but rather, the data may stay in one place, and pointers may be passed between VMs 904 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 922 is illustrated, wherein vSwitch 922 is shared between two or more physical hardware platforms 902.

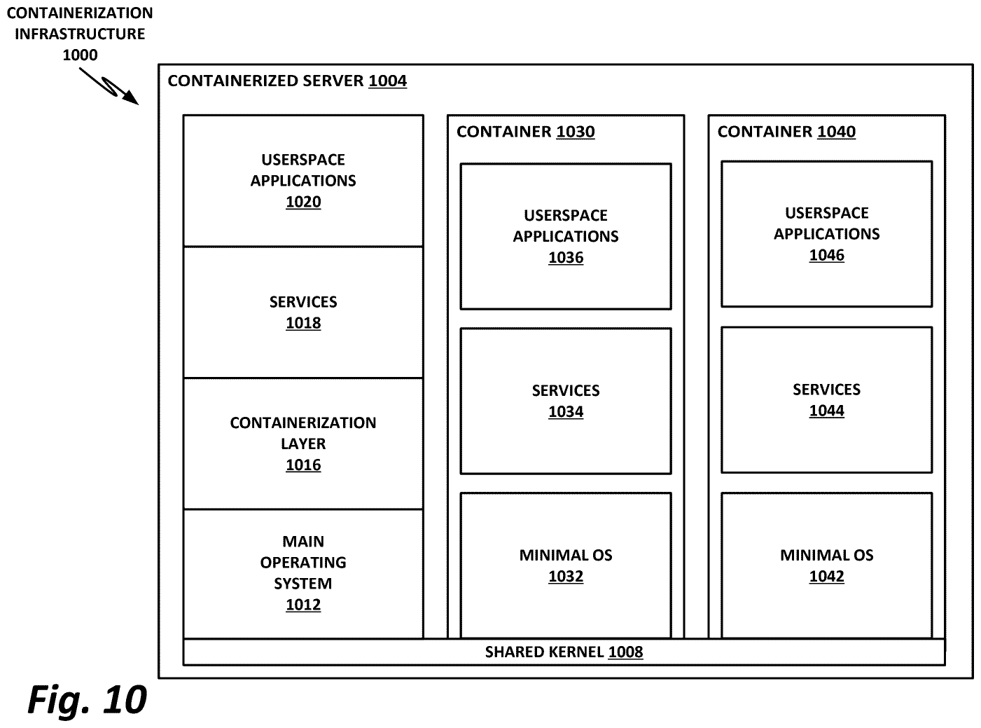

FIG. 10 is a block diagram of selected elements of a containerization infrastructure 1000. Like virtualization, containerization is a popular form of providing a guest infrastructure. Various functions described herein may be containerized. For example, the data preparation and orchestration functions disclosed above may be provided in containers, as may be any other suitable element.

Containerization infrastructure 1000 runs on a hardware platform such as containerized server 1004. Containerized server 1004 may provide processors, memory, one or more network interfaces, accelerators, and/or other hardware resources.

Running on containerized server 1004 is a shared kernel 1008. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1008 is main operating system 1012. Commonly, main operating system 1012 is a Unix or Linux-based operating system, although containerization infrastructure is also available for other types of systems, including Microsoft Windows systems and Macintosh systems. Running on top of main operating system 1012 is a containerization layer 1016. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1012 may also provide services 1018, which provide services and interprocess communication to userspace applications 1020.

Services 1018 and userspace applications 1020 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1012, they inherit the same file and resource access permissions as those provided by shared kernel 1008. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1004, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1004).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors-provide such near-native performance that this advantage may not always be realized.

In this example, containerized server 1004 hosts two containers, namely container 1030 and container 1040.

Container 1030 may include a minimal operating system 1032 that runs on top of shared kernel 1008. Note that a minimal operating system is provided as an illustrative example, and is not mandatory. In fact, container 1030 may perform as full an operating system as is necessary or desirable. Minimal operating system 1032 is used here as an example simply to illustrate that in common practice, the minimal operating system necessary to support the function of the container (which in common practice, is a single or monolithic function) is provided.

On top of minimal operating system 1032, container 1030 may provide one or more services 1034. Finally, on top of services 1034, container 1030 may also provide userspace applications 1036, as necessary.

Container 1040 may include a minimal operating system 1042 that runs on top of shared kernel 1008. Note that a minimal operating system is provided as an illustrative example, and is not mandatory. In fact, container 1040 may perform as full an operating system as is necessary or desirable. Minimal operating system 1042 is used here as an example simply to illustrate that in common practice, the minimal operating system necessary to support the function of the container (which in common practice, is a single or monolithic function) is provided.

On top of minimal operating system 1042, container 1040 may provide one or more services 1044. Finally, on top of services 1044, container 1040 may also provide userspace applications 1046, as necessary.

Using containerization layer 1016, containerized server 1004 may run discrete containers, each one providing the minimal operating system and/or services necessary to provide a particular function. For example, containerized server 1004 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

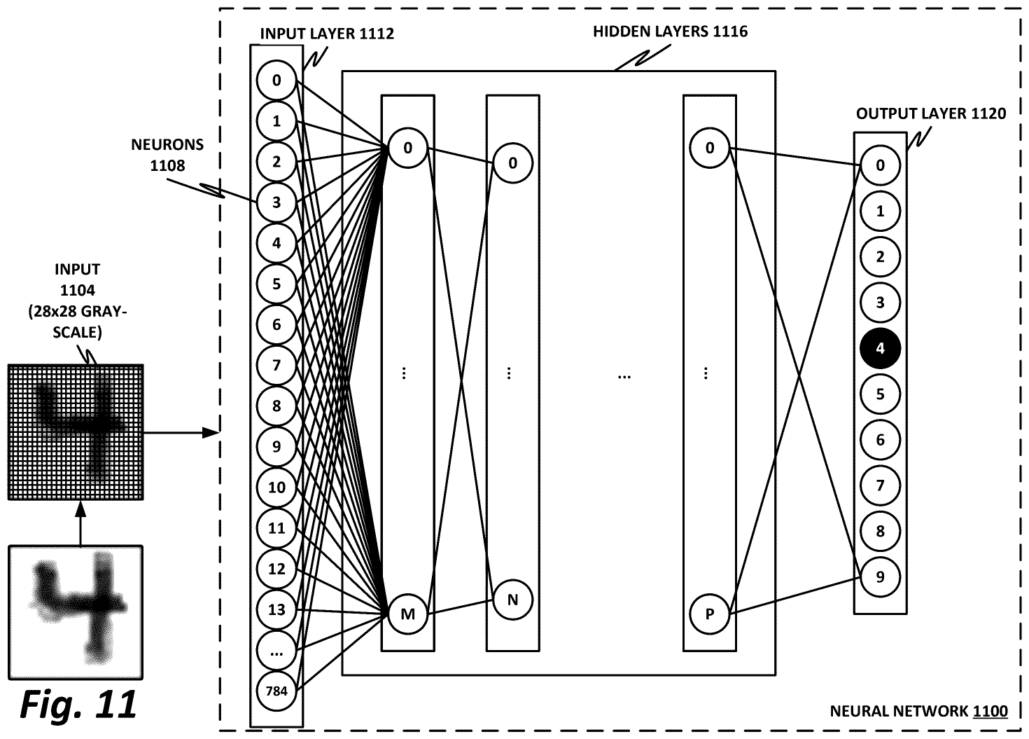

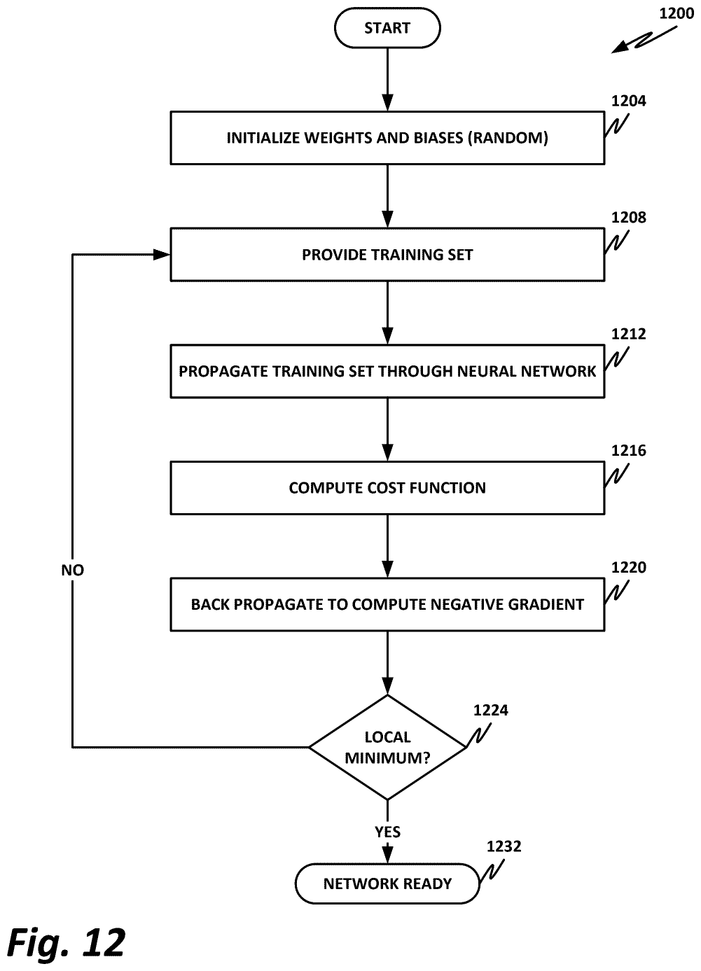

FIGS. 11 and 12 illustrate selected elements of an artificial intelligence system or architecture. In these FIGURES, an elementary neural network is used as a representative embodiment of an artificial intelligence (AI) or machine learning (ML) architecture or engine. These figures represent a nonlimiting example AI. The purpose of these figures is not necessarily to exhaustively reproduce the AI elements of the present specification. The AI principles disclosed in this specification are well-understood in the art, and the system and method of providing an AI with multiple constraints disclosed herein are not intended to claim AI itself as a novel technology. Rather, the system and method illustrate a novel application of known AI principles. Thus, the figures provided here are intended to review some foundational concepts of AI (particularly “deep learning” in the context of a deep neural network) and provide a meaningful vocabulary for discussion of AI terms used throughout this specification.

The deep learning network illustrated here should thus be understood to represent AI principles in general. Other machine learning or artificial intelligence architectures are available, including for example symbolic learning, robotics, computer vision, pattern recognition, statistical learning, speech recognition, natural language processing, deep learning, convolutional neural networks, recurrent neural networks, object recognition and/or others.

FIG. 11 illustrates machine learning according to a “textbook” problem with real-world applications. In this case, a neural network 1100 is tasked with recognizing characters. To simplify the description, neural network 1100 is tasked only with recognizing single digits in the range of 0 through 9. These are provided as an input image 1104. In this example, input image 1104 is a 28×28-pixel 8-bit grayscale image. In other words, input image 1104 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 1100 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other artificial intelligence architecture, to meet the demands of a particular problem. Indeed, the architecture here is sometimes referred to as the “Hello World” problem of machine learning, and is provided as but one example of how the machine learning or artificial intelligence functions of the present specification could be implemented.

In this case, neural network 1100 includes an input layer 1112 and an output layer 1120. In principle, input layer 1112 receives an input such as input image 1104, and at output layer 1120, neural network 1100 “lights up” a perceptron that indicates which character neural network 1100 thinks is represented by input image 1104.

Between input layer 1112 and output layer 1120 are some number of hidden layers 1116. The number of hidden layers 1116 will depend on the problem to be solved, the available compute resources, and other design factors. In general, the more hidden layers 1116, and the more neurons per hidden layer, the more accurate the neural network 1100 may become. However, adding hidden layers and neurons also increases the complexity of the neural network, and its demand on compute resources. Thus, some design skill is required to determine the appropriate number of hidden layers 1116, and how many neurons are to be represented in each hidden layer 1116.

Input layer 1112 includes, in this example, 784 “neurons” 1108. Each neuron of input layer 1112 receives information from a single pixel of input image 1104. Because input image 1104 is a 28×28 grayscale image, it has 784 pixels. Thus, each neuron in input layer 1112 holds 8 bits of information, taken from a pixel of input layer 1104. This 8-bit value is the “activation” value for that neuron.

Each neuron in input layer 1112 has a connection to each neuron in the first hidden layer in the network. In this example, the first hidden layer has neurons labeled 0 through M. Each of the M+1 neurons is connected to all 784 neurons in input layer 1112. Each neuron in hidden layer 1116 includes a kernel or transfer function, which is described in greater detail below. The kernel or transfer function determines how much “weight” to assign each connection from input layer 1112. In other words, a neuron in hidden layer 1116 may think that some pixels are more important to its function than other pixels. Based on this transfer function, each neuron computes an activation value for itself, which may be for example a decimal number between 0 and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 1116, until they reach the last layer, which has P+1 neurons labeled 0 through P. Each of these P+1 neurons has a connection to each neuron in output layer 1120. Output layer 1120 includes a number of neurons known as perceptrons that compute an activation value based on their weighted connections to each neuron in the last hidden layer 1116. The final activation value computed at output layer 1120 may be thought of as a “probability” that input image 1104 is the value represented by the perceptron. For example, if neural network 1100 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 1116 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (σ) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

$${a}_{0}^{( 1 )} = σ ( {w}_{0} {a}_{0}^{( 0 )} + {w}_{1} {a}_{1}^{( 0 )} + … {w}_{783} {a}_{783}^{( 0 )} + b )$$

In this case, it is assumed that layer 0 (input layer 1112) has 784 neurons. Where the previous layer has “n” neurons, the function can be generalized as:

$${a}_{0}^{( 1 )} = σ ( {w}_{0} {a}_{0}^{( 0 )} + {w}_{1} {a}_{1}^{( 0 )} + … {w}_{n} {a}_{n}^{( 0 )} + b )$$

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$${a}^{( 1 )} = σ ( [ \begin{matrix}{w}_{0 , 0} & … & {w}_{0 , n} \\ ⋮ & ⋱ & ⋮ \\ {w}_{( k , 0 )} & … & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

$${a}^{( 1 )} = σ ( {Wa}^{( 0 )} + b )$$

Neural connections and activation values are propagated throughout the hidden layers 1116 of the network in this way, until the network reaches output layer 1120. At output layer 1120, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 1120 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as Accounting, Information Technology (IT), and Human Resources. On the other hand, the activation values for perceptrons for Legal, Manufacturing, and Shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights-and-biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

C(w)

Wherein w is a vector containing all of the parameters (weights and biases) in the network. The minimum (absolute and/or local) can then be represented as a trivial calculus problem, namely:

$$\frac{dC}{dw} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

−∇C(w)

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolute minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost function.

FIG. 12 is a flowchart of a method 1200. Method 1200 may be used to train a neural network, such as neural network 1100 of FIG. 11.

In block 1204, the network is initialized. Initially, neural network 1100 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between 0 and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1208, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1208, the initial training set is provided to the neural network. Alternatively, the full training set could be used in each iteration.

In block 1212, the training data are propagated through the neural network. Because the initial values are random, and are therefore essentially garbage, it is expected that the output will also be a garbage value. In other words, if neural network 1100 of FIG. 11 has not been trained, when input image 1104 is fed into the neural network, it is not expected with the first training set that output layer 1120 will light up perceptron 4. Rather, the perceptrons may have values that are all over the map, with no clear winner, and with very little relation to the number 4.

In block 1216, a cost function is computed as described above. For example, in neural network 1100, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1220, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1224, the system determines whether it has reached a local minimum (e.g., whether the gradient has reached 0 within the threshold). If the local minimum has not been reached, then the neural network has not been adequately trained, and control returns to block 1208 with a new training set. The training sequence continues until, in block 1224, a local minimum has been reached.

Now that a local minimum has been reached and the corrections have been back-propagated, in block 1232, the neural network is ready.

Although FIGS. 11 and 12 illustrate an AI application for recognizing characters, that function does not represent the limit of modern-day AI practice. AIs have been adapted to many tasks, and generative AIs (GAI) are also common now. For example, generative pre-trained transformer (GPT) networks are popular for their ability to naturally interact with human users, effectively imitating human speech patterns. GAI networks have also been trained for creating and modifying art, engineering designs, books, and other information.

Many of the foregoing GAIs are general-purpose GAIs, meaning that they are trained on very large data sets (e.g., on the order of many terabytes of data), and have general knowledge on many subjects. However, domain-specific AIs are also used in other contexts. General-purpose AIs are generally trained on very large data sets in an unsupervised or semi-unsupervised regimen, which provides the breadth that may benefit a general-purpose AI. Domain-specific AIs are often based on general-purpose AIs, and may start from a pre-trained model. The pre-trained model can then be refined and re-trained using supervised learning, such as with structured, curated, and tagged data sets. This supervised learning can morph the AI model into a model that has specialized utility in a specific knowledge domain.

The foregoing outlines features of several embodiments so that those skilled in the art may better understand various aspects of the present disclosure. The foregoing detailed description sets forth examples of apparatuses, methods, and systems relating to providing artificial intelligence queries with multiple constraints, accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random-access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1-68. (canceled)

69. A computer-implemented method, comprising:
receiving, from a human user, a natural language query;
modifying the natural language query (a modified query) and posting the modified query to a general-purpose artificial intelligence (AI);
receiving, from the general-purpose AI, a raw response to the modified query;
providing the raw response to a plurality of guardrail AIs, wherein the guardrail AIs are to provide domain-specific evaluations of the raw response;
receiving, from the plurality of guardrail AIs, the domain-specific evaluations;
forwarding a version of the raw response to the human user; and
acting on the domain-specific evaluations.

70. The method of claim 69, wherein modifying the natural language query comprises building a multi-constraint prompt for the general-purpose AI, and providing the multi-constraint prompt as part of the modified query.

71. The method of claim 70, wherein the multi-constraint prompt comprises three or more constraints.

72. The method of claim 70, wherein the multi-constraint prompt comprises constraints that correlate to the domain-specific evaluations of the guardrail AIs.

73. The method of claim 69, wherein modifying the natural language query comprises providing a document from a prepared enterprise data set, and instructing the general-purpose AI to answer the natural language query according to the document.

74. The method of claim 69, wherein the general-purpose AI is a large language model (LLM).

75. The method of claim 74, wherein the LLM is a third-party LLM.

76. The method of claim 69, wherein the guardrail AIs are domain-specific LLMs.

77. The method of claim 69, wherein the version of the raw response is the raw response.

78. The method of claim 69, wherein the version of the raw response is modified from the raw response.

79. The method of claim 69, wherein acting on the domain-specific evaluations comprises forwarding the version of the raw response only after determining that the raw response passed the domain-specific evaluations.

80. The method of claim 69, further comprising forwarding the version of the raw response while the domain-specific evaluations are ongoing.

81. The method of claim 80, further comprising interrupting the version of the raw response if the raw response failed at least one domain-specific evaluation.

82. The method of claim 69, wherein acting on the domain-specific evaluations comprises warning the human user if at least one domain-specific evaluation failed.

83. The method of claim 82, wherein warning the human user comprises providing information about which domain-specific evaluation or evaluations failed.

84. One or more tangible, nontransitory computer-readable storage media having stored thereon executable instructions to:
receive, from a human user, a natural language query;
modify the natural language query (a modified query) and post the modified query to a general-purpose artificial intelligence (AI);
receive, from the general-purpose AI, a raw response to the modified query;
provide the raw response to a plurality of guardrail AIs, wherein the guardrail AIs are to provide domain-specific evaluations of the raw response;
receive, from the plurality of guardrail AIs, the domain-specific evaluations;
forward a version of the raw response to the human user; and
act on the domain-specific evaluations.

85. The one or more tangible, nontransitory computer-readable storage media of claim 84, wherein modifying the natural language query comprises building a multi-constraint prompt for the general-purpose AI, and providing the multi-constraint prompt as part of the modified query, wherein the multi-constraint prompt comprises three or more constraints.

86. The one or more tangible, nontransitory computer-readable storage media of claim 85, wherein the multi-constraint prompt comprises constraints that correlate to the domain-specific evaluations of the guardrail AIs.

87. An orchestrator apparatus for providing artificial intelligence (AI)-assisted responses to a human user, comprising:
a hardware platform, comprising a processor circuit and a memory; and
instructions encoded within the memory to instruct the processor circuit to:
receive, from the human user, a natural language query;
modify the natural language query (a modified query) and post the modified query to a general-purpose AI;
receive, from the general-purpose AI, a raw response to the modified query;
provide the raw response to a plurality of guardrail AIs, wherein the guardrail AIs are to provide domain-specific evaluations of the raw response;
receive, from the plurality of guardrail AIs, the domain-specific evaluations;
forward a version of the raw response to the human user; and
act on the domain-specific evaluations.

88. The orchestrator apparatus of claim 87, wherein modifying the natural language query comprises building a multi-constraint prompt for the general-purpose AI, and providing the multi-constraint prompt as part of the modified query.
